(19) United States
(12) Patent Application Publication
(10) Pub. No.: US 2017/0085734 A1
(43) Pub. Date: Mar. 23, 2017

(54) PRINTER

(71) Applicant: TOSHIBA TEC KABUSHIKI KAISHA, Tokyo (JP)

(72) Inventors: Shu Satake, Kawasaki Kanagawa (JP); Masami Yamanashi, Izunokuni Shizuoka (JP); Michio Suzuki, Tagata Shizuoka (JP)

(21) Appl. No.: 15/264,809

(22) Filed: Sep. 14, 2016

(30) Foreign Application Priority Data
Sep. 18, 2015 (JP) 2015-185791

(51) Int. Cl. H04N 1/00; H04W 4/00

(52) U.S. Cl. CPC H04N 1/00832; H04W 4/008; H04N 1/00015; H04N 1/00042; H04N 1/0009; H04N 2201/0096; H04N 2201/006; H04N 2201/0072

(57) ABSTRACT

In accordance with an embodiment, a printer comprises a printing processor configured to execute a printing processing on a conveyed sheet; a near field communication device including a non-volatile rewritable storage module and configured to carry out input or output of information to or from the storage module through a near field communication caused by an induced electromotive force generated by a carrier wave from an external device; a status reception module configured to receive a status indicating a state of the printing processor; and a status storage module configured to store the status received through the status reception module in the storage module of the near field communication device.

### CROSS-REFERENCE TO RELATED APPLICATION

This application is based upon and claims the benefit of priority from Japanese Patent Application No. P2015-185791, filed Sep. 18, 2015, the entire contents of which are incorporated herein by reference.

### FIELD

Embodiments described herein relate generally to a printer.

### BACKGROUND

Conventionally, a portable printer becomes popular in a variety of applications such as a home delivery service or an inventory management.

Incidentally, the conventional portable printer stores various statuses indicating states relating to a printing processing in a memory arranged in the printer in advance. Through storing various statuses in this way, a cause of failure is explored in a case in which the failure occurs and the stored status can be fed back.

However, there is a problem that the printer which stores various statuses in the memory as described above cannot acquire the status (for example, error history information) before the failure in a case in which a power supply system of the printer breaks down.

### DESCRIPTION OF THE DRAWINGS

FIG. 1 is a schematic front view illustrating the appearance of a printer according to an embodiment;

FIG. 2 is a diagram illustrating conveyance of a label and a printing mechanism;

FIG. 3 is a block diagram illustrating the hardware structure of the printer;

FIG. 4 is a block diagram illustrating the structure of a near field communication device;

FIG. 5 is a functional block diagram illustrating functional components of the printer; and

FIG. 6 is a flowchart illustrating the flow of a control processing of the printer.

### DETAILED DESCRIPTION

In accordance with an embodiment, a printer comprises a printing processor configured to execute a printing processing on a conveyed sheet, a near field communication device including a non-volatile rewritable storage module and configured to carry out input or output of information to or from the storage module through a near field communication caused by an induced electromotive force generated by a carrier wave from an external device, a status reception module configured to receive a status indicating a state of the printing processor, and a status storage module configured to store the status received through the status reception module in the storage module of the near field communication device.

In accordance with an embodiment, a printing method involving executing printing on a conveyed sheet; carrying out input or output of information using a near field communication caused by an induced electromotive force generated by a carrier wave from an external device; receiving a status indicating a state of the printing; and storing the status received in a storage module of a near field communication device.

Hereinafter, the printer according to the present embodiment is described with reference to the accompanying drawings. Further, in the present embodiment, for example, a battery-driven portable printer to be used while mounted on a human body (for example, attached to a belt or in a holster) of a person in charge of delivery service of a merchandise is described as an example of the printer. Such a printer is used to, for example, print absence notification information on a label (print medium) to issue the printed label if there is no delivery destination. Hereinafter, in the embodiment, the portable printer is simply referred to as a printer. Further, the invention is not limited through the embodiment described below.

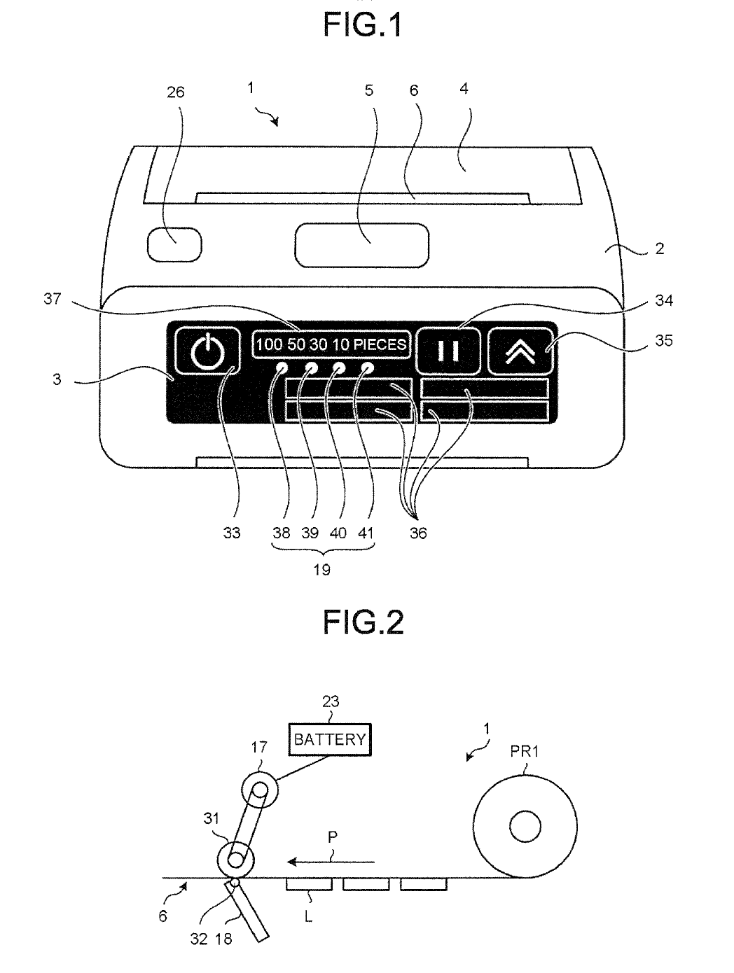

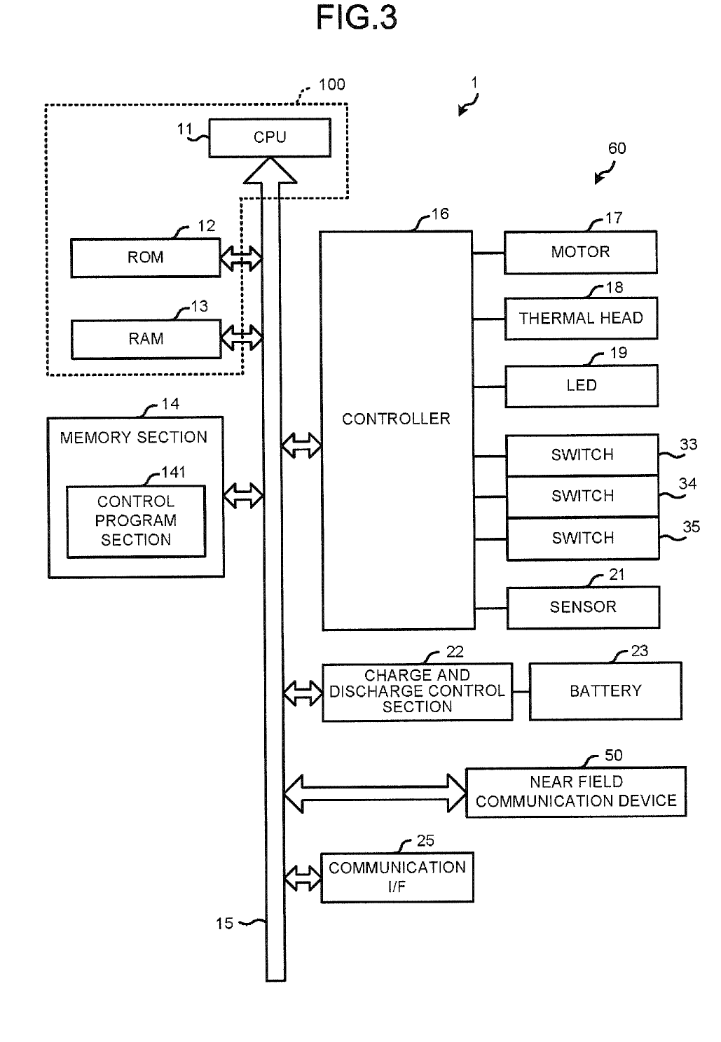

FIG. 1 is a schematic front view illustrating the appearance of a printer 1 according to an embodiment. As shown in FIG. 1, the printer 1 which is an approximately rectangular parallelepiped shape includes a main body 2 and a cover 4. Though detailed description of the main body 2 is given with reference to FIG. 2 and FIG. 3, the main body 2 is equipped with a circuit board (not shown), a thermal head 18 including a plurality of heat generation elements 32 linearly arranged, a platen and conveyance roller 31 (hereinafter, referred to as a platen 31) connected with a motor 17, a battery 23, and a communication section 26 at the inside thereof. The main body 2 is equipped with an opening switch 5 for opening the cover 4 from a closed state and a slit 6. The foregoing thermal head 18, the motor 17, the battery 23, the communication section 26 constitute a printing processing section 60 for executing a printing processing on a conveyed sheet PR1.

The main body 2 can set a rolled sheet PR1 (refer to FIG. 2) formed by arranging a label L (refer to FIG. 2) of the same shape at equal intervals on a long mount at the inside thereof. The main body 2 rotatably holds the sheet PR1. The sheet PR1 is set in the main body 2 by opening the cover 4. The printer 1 prints the absence notification information on the label L pulled out from the set sheet PR1 and discharges the printed label from the slit 6 to the outside to issue the label L on which the printing is completed.

The main body 2 is equipped with a display or display section 3 at the front part thereof. The display section 3 displays a switch 33, a switch 34, and a switch 35. The switch 33 is a power supply switch, and the printer 1 repeats the on-off of the power supply every time the switch 33 is operated. The switch 34 is a switch for temporarily stopping the printing operation in the printer 1, and the printer 1 repeats temporary stop of the printing operation and the restarting of the printing operation every time the switch 34 is operated. The switch 35 is a switch for fast feeding the label L in the printer 1. While the switch 35 is operated, the printer 1 fast feeds the label L.

In particular, touch panels (not shown) are arranged at the upper part of the switch 33, the switch 34 and the switch 35. Through the pressing on the touch panel at a position corresponding to the displayed switch 33, the switch 34 or the switch 35 as an operation on the corresponding switch, a processing corresponding to the operated switch is executed.

The display section 3 is equipped with an error display section 36 for carrying out various kinds of error display. The error display section 36 displays, for example, characters such as “Cover is opened”, “Paper is end” or “Notification error”. The error display section 36 enables a notification, such as by a LED (Light Emitting Diode) arranged at the back part thereof facing each character display to emit light to inform the corresponding error.

The display section 3 is equipped with a remaining number display section 37 for displaying remaining printing number (quantity information). In the present embodiment, the remaining number display section 37 displays numerals including “100 50 30 10” indicating the remaining printing number in a row at equal intervals. The numeral acts as a standard indicating how many labels L can be printed later through the remaining capacity of the battery 23. The numeral “100” serving as the quantity information indicates that the remaining printing number is about 100. The numeral “50” serving as the quantity information indicates that the remaining printing number is about 50. The numeral “30” serving as the quantity information indicates that the remaining printing number is about 30. The numeral “10” serving as the quantity information indicates that the remaining printing number is about 10.

The display section 3 is equipped with LEDs 38˜41 at positions (in the present embodiment, at the lower part of the numerals) corresponding to numerals on the display section 3. The LED 38 is arranged at the lower part of the numeral “100”, the LED 39 is arranged at the lower part of the numeral “50”, the LED 40 is arranged at the lower part of the numeral “30”, and the LED 41 is arranged at the lower part of the numeral “10”. These LEDs 38˜41 is collectively referred to as an LED 19.

By lighting the LED 38, the printer 1 informs that about 100 labels can be printed later at a high speed. By lighting the LED 39, the printer 1 informs that about 50 labels can be printed later at a high speed. By lighting the LED 40, the printer 1 informs that about 30 labels can be printed later at a high speed. By lighting the LED 41, the printer 1 informs that about 10 labels can be printed at a high speed later. By blinking the LED 41, the printer 1 informs that about 10 labels can be printed later at a low speed. An operator of the printer 1 can figure out the printer 1 can print how many labels L later through the remaining capacity of the battery 23 on the basis of the LED 19 that is lit or blinked.

FIG. 2 is a diagram illustrating the conveyance of the label L and a printing mechanism. As shown in FIG. 2, in the main body 2 of the printer 1, the sheet PR1 is set in a manner capable of pulling out the label L. The sheet PR1 is formed by arranging a plurality of the labels L of the same shape at equal intervals on the wound mount. The back surface of the label L is coated by adhesive, and the label L adheres to the mount in a peelable manner through the adhesive.

The surface of the label L is coated by color former that develops black or other colors by being applied with heat . In the conveyance path of the label L, the thermal head 18 and the platen 31 opposed to each other elastically contact with each other.

As shown in FIG. 2, the thermal head 18 is energized upwards, and the platen 31 is energized downwards . The mount and the label L pulled out from the sheet PR1 are conveyed in an arrow P direction and are elastically sandwiched by the thermal head 18 and the platen 31 at a contact point between the thermal head 18 and the platen 31. The surface of the label L contacts the heat generation element 32 linearly arranged on the thermal head 18 at the contact point. The back surface of the label L elastically contacts the platen 31 at the contact point.

The platen 31 rotates through the rotation of the motor 17 to which electric power is supplied from the battery 23 to convey the label L in the arrow P direction. If a lot of the electric power is supplied from the battery 23 and the motor 17 rotates at a high speed, the platen 31 conveys the label L at a high speed. If the supply of the electric power from the battery 23 is reduced and the motor 17 rotates at a low speed, the platen 31 conveys the label L at a low speed. The label L, conveyed by the platen 31, on which the absence notification information is printed by the thermal head 18 is discharged to the outside of the printer 1 from the slit 6 to be issued.

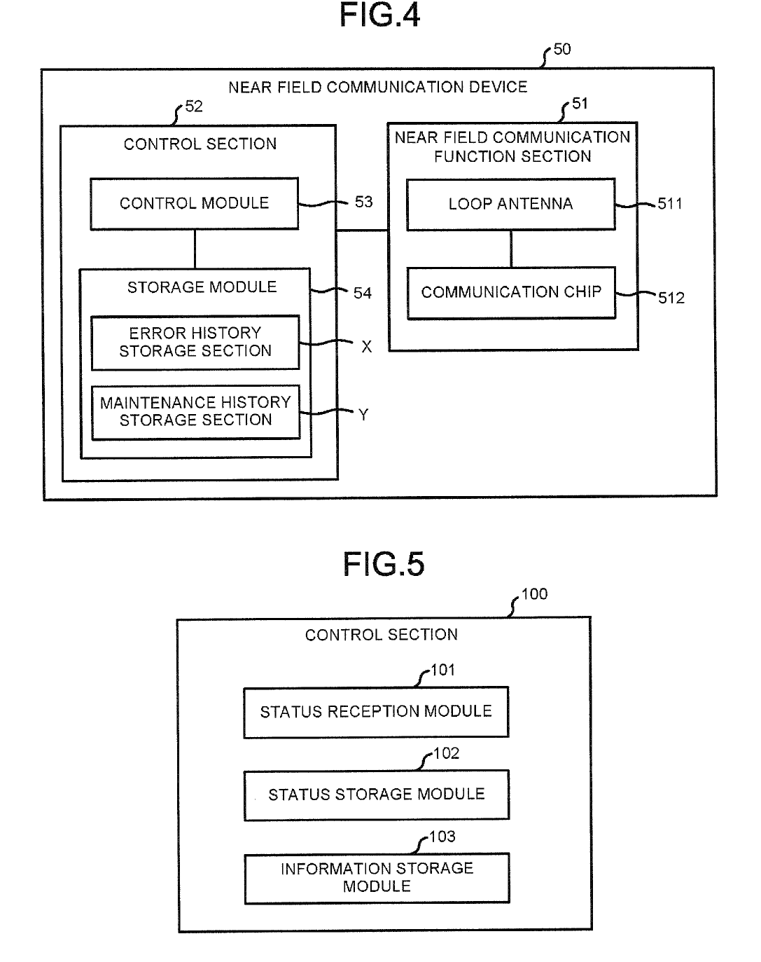

Next, the hardware structure of the printer 1 is described with reference to FIG. 3 and FIG. 4. FIG. 3 is a block diagram illustrating the hardware structure of the printer 1. As shown in FIG. 3, the printer 1 is equipped with a CPU (Central Processing Unit) 11, a ROM (Read Only Memory) 12, a RAM (Random Access Memory) 13 and a memory section 14. The CPU 11 becomes a control main body. The ROM 12 stores various programs. The RAM 13 copies or decompresses various data. The memory section 14 stores various programs. The CPU 11, the ROM 12, the RAM 13 and the memory section 14 are connected with each other via a data bus 15. The CPU 11, the ROM 12 and the RAM 13 constitute a control section 100. The CPU 11 operates according to a control program copied or decompressed on the RAM 13 stored in the ROM 12 and the memory section 14, and thus, the control section 100 executes a control processing described later.

The memory section 14 is a non-volatile memory such as an HDD (Hard Disc Drive), a flash memory or the like in which storage information is held even if the power source is turned off, and is equipped with a control program section 141 for storing a control program.

The control section 100 is connected with the motor 17, the thermal head 18, the various LEDs 19 including the LED 38, the LED 39, the LED 40 and the LED 41, the switch 33, the switch 34, the switch 35, and various sensors 21 via the data bus 15 and a controller 16. The sensor 21 includes a sensor for determining a home position of the label L on which the printing operation is started, a sensor for determining a stop position of the label L discharged from the slit 6, an end detection sensor of the label L and the like. Various sensors 21 constitute the printing processor or printing processing section 60 for executing the printing processing on the conveyed sheet PR1.

The control section 100 is connected with a charge and discharge control section 22 via the data bus 15. The charge and discharge control section 22 is connected with the battery 23, and receives a control instruction for charging the battery 23 from a commercial power supply (not shown) or a control instruction for enabling the battery 23 to discharge to supply the electric power to the motor 17, the thermal head 18 and the LEDs 19 from the control section 100 to directly control the battery 23.

The control section 100 is connected with a communication I/F 25 via the data bus 15. The communication I/F 25 uses, for example, wireless communication technology to receive print information from a handy terminal (not shown) serving as an external device. The handy terminal in the present embodiment is, for example, a portable terminal for sending the absence notification information to the printer 1 in a case in which a resident of a delivery destination to which a commodity is delivered is absent. The printer 1 receives the absence notification information from the handy terminal via the communication I/F 25.

In addition, the control section 100 is connected with a near field communication device 50 via the data bus 15. The structure of the near field communication device 50 is described.

FIG. 4 is a block diagram illustrating the structure of the near field communication device 50. As shown in FIG. 4, the near field communication device 50 is a circuit such as an IC (Integrated Circuit) tag or a RFID (Radio Frequency Identification) tag and is equipped with an NFC (Near Field Communication) function section (hereinafter, referred to as a near field communication function section) 51 and a control section 52.

The near field communication device 50 of the printer 1 according to the present embodiment may adopt a non-contact type for carrying out the near field communication in a non-contact manner. The non-contact type near field communication function section 51 is constituted by connecting a closed-circuit antenna (loop antenna) 511 formed by winding a copper wire for plural times with a communication chip 512. The non-contact type near field communication function section 51 carries out the near field communication through sending of a carrier wave form a coil of the external device serving as a communication partner through a passive method.

In particular, through the carrier wave from the external device, magnetic flux density of the loop antenna 511 of the near field communication function section 51 changes and the induced electromotive force is generated in the closed circuit, the communication chip 512 carries out the near field communication through the electric power.

As shown in FIG. 4, the control section 52 of the near field communication device 50 is equipped with a control module 53 and a storage module 54.

The control module 53 is a control circuit for performing control of the near field communication function section 51. The storage module 54 is a non-volatile rewritable memory such as a Flash ROM. The storage module 54 is equipped with an error history storage section X and a maintenance history storage section Y. Further, the storage module 54 may store an ID (for example, pairing ID of Bluetooth (registered trademark)) for providing a link with a communication partner such as the handy terminal (not shown).

The error history storage section X is used to store error history information indicating a status from the printing processing section 60 (the thermal head 18, various sensors 21 and the like) in a case in which a state is generated in which the printing processing cannot be continued in the printing processing section 60 (the thermal head 18, various sensors 21 and the like). As the error history information, for example, statuses such as head disconnection of the thermal head 18, a paper jam detected by various sensors 21 and the like are exemplified.

The maintenance history storage section Y is used to store maintenance history information indicating maintenance history such as exchange of the thermal head 18 or exchange of the circuit board (not shown) and the like.

The near field communication function section 51 takes out a signal from the carrier wave from the external device which is a communication partner such as the handy terminal (not shown) to transfer a command and data included in the signal to the control module 53. As a concrete example of the command and data included in the signal, there is the maintenance history information (for example, the maintenance history such as the exchange of the thermal head 18) sent from the handy terminal.

The near field communication function section 51 receives the data from the control module 53 and sends data to the handy terminal (not shown) on the carrier wave. In the present embodiment, if receiving a request for transmission of the error history information and the maintenance history information from the handy terminal (not shown), the near field communication function section 51 sends the error history information and the maintenance history information in the storage module 54 on reflected wave of the carrier wave towards the handy terminal (not shown) serving as a request destination.

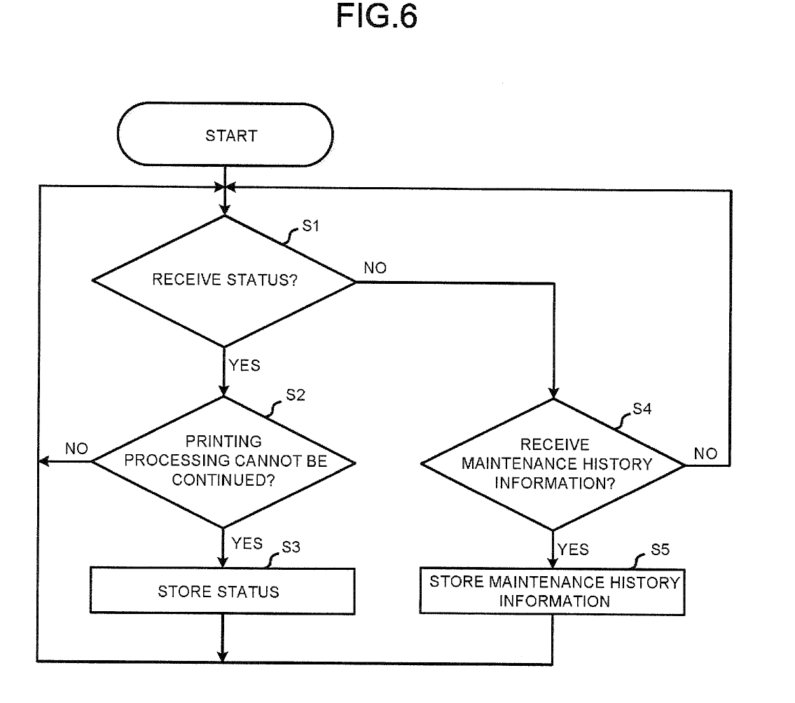

Next, the control processing of the printer 1 is described with reference to FIG. 5·Fig. 6. FIG. 5 is a functional block diagram illustrating functional components of the printer 1. As shown in FIG. 5, the control section 100 functions as a status reception module 101, a status storage module 102 and an information storage module 103 according to a control program stored in the control program section 141 in the ROM 12 and the memory section 14.

The status reception module 101 receives a status indicating a state of the printing processing section 60 (the thermal head 18, various sensors 21 and the like).

The status storage module 102 stores a status received by the status reception module 101 in the storage module 54 (the error history storage section X) of the near field communication device 50. More specifically, the status storage module 102 takes the generation of a state in which the printing processing cannot be continued in the printing processing section 60 (the thermal head 18, various sensors 21 and the like) as a condition and stores the error history information indicating the status from the printing processing section 60 (the thermal head 18, various sensors 21 and the like) received by the status reception module 101 in the storage module 54 (the error history storage section X) of the near field communication device 50.

Further, the status storage module 102 may store the status received through the status reception module 101 in a RAM serving as an auxiliary storage module, take the generation of a state in which the printing processing cannot be continued in the printing processing section 60 (the thermal head 18, various sensors 21 and the like) as a condition, and store the error history information indicating the status from the printing processing section 60 (the thermal head 18, various sensors 21 and the like) which relates to the generation of the state in which the printing processing cannot be continued from the RAM to the storage module 54 (the error history storage section X) of the near field communication device 50.

If an amount of the statuses stored in the storage module 54 (the error history storage section X) of the near field communication device 50 is greater than a certain amount, the status storage module 102 overwrites a new status in a storage area in which an old status is stored.

If considering the amount of data, the error history information may be identification number for identifying each error.

The information storage module 103 stores the maintenance history information received from the external device (for example, the handy terminal) via the near field communication device 50 in the storage module 54 (the maintenance history storage section Y) of the near field communication device 50.

If an amount of the maintenance history information stored in the storage module 54 (the maintenance history storage section Y) of the near field communication device 50 is greater than a threshold amount, the information storage module 103 overwrites new maintenance history information in a storage area in which old maintenance history information is stored.

FIG. 6 is a flowchart illustrating the flow of the control processing of the printer 1. As shown in FIG. 6, the status reception module 101 of the printer 1 receives the status indicating the state of the printing processing section 60 (the thermal head 18, various sensors 21 and the like) (Yes in Act S1).

In a case in which the state in which the printing processing cannot be continued is generated in the printing processing section 60 (the thermal head 18, various sensors 21 and the like) (Yes in Act S2), the status storage module 102 of the printer 1 stores the received error history information indicating the status from the printing processing section 60 (the thermal head 18, various sensors 21 and the like) in the storage module 54 (the error history storage section X) of the near field communication device 50 (Act S3).

On the other hand, if receiving the maintenance history information from the external device (for example, the handy terminal) via the near field communication device 50 (Yes in Act S4), the information storage module 103 of the printer 1 stores the received maintenance history information in the storage module 54 (the maintenance history storage section Y) of the near field communication device 50 (Act S5).

Thus, at the time of exploring a failure cause in a case in which failure occurs, even in a case in which the power supply system of the printer 1 breaks down, only by putting a device capable of executing NFC (Near Field Communication) close to the printer 1 and holding the device over the printer 1, the status (the error history information) and the maintenance history information before the failure can be acquired from the storage module 54 (the error history storage section X and the maintenance history storage section Y).

In this way, according to the printer 1 of the embodiment, by storing the status (the error history information) and the maintenance history information before the failure in the storage module 54 (the error history storage section X and the maintenance history storage section Y) of the near field communication device 50 in advance, since it is possible to read out the status (the error history information) and the maintenance history information with a necessary scene, the efficiency of quality monitoring and maintenance request job can be innovatively improved.

The program executed by the printer 1 the embodiment may be recorded in a computer-readable recording medium such as a CD-ROM, a FD (Flexible Disk) , a CD-R, a DVD (Digital Versatile Disk) and the like in the form of installable or executable file to be provided.

Further, the program executed by the printer 1 of the embodiment is stored in a computer connected with a network such as an internet and downloaded via the network to be supplied. The program executed by the printer 1 of the embodiment may be supplied or distributed via the network such as the Internet.

The program executed by the printer 1 of the embodiment may be incorporated into a ROM in advance to be provided.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A printer, comprising:
a printing processor configured to execute a printing processing on a conveyed sheet;
a near field communication device comprising a non-volatile rewritable storage module and configured to carry out input or output of information to or from the storage module through a near field communication caused by an induced electromotive force generated by a carrier wave from an external device;
a status reception module configured to receive a status indicating a state of the printing processor; and
a status storage module configured to store the status received through the status reception module in the storage module of the near field communication device.

2. The printer according to claim 1, wherein
the status storage module takes generation of a state in which the printing processing cannot be continued in the printing processor as a condition and stores a status from the printing processor received through the status reception module in the storage module of the near field communication device.

3. The printer according to claim 1, wherein
the status storage module stores the status received through the status reception module in an auxiliary storage module, takes generation of a state in which the printing processing cannot be continued in the printing processor as a condition, and stores a status from the printing processor which relates to the generation of the state in which the printing processing cannot be continued from the auxiliary storage module to the storage module of the near field communication device.

4. The printer according to claim 1, further comprising
an information storage module configured to store information received from an external device via the near field communication device in the storage module of the near field communication device.

5. The printer according to claim 1, wherein
if an amount of the statuses stored in the storage module of the near field communication device is greater than a threshold amount, the status storage module overwrites a new status in a storage area in which an old status is stored.

6. The printer according to claim 1, wherein the printer is powered by battery power.

7. The printer according to claim 1, wherein the printer is portable.

8. The printer according to claim 1, wherein the status comprises error history information.

9. The printer according to claim 1, wherein the near field communication device comprises an RFID tag.

10. The printer according to claim 1, wherein the near field communication device comprises a non-contact type near field communication device.

11. A printing method, comprising:
executing printing on a conveyed sheet;
carrying out input or output of information using a near field communication caused by an induced electromotive force generated by a carrier wave from an external device;
receiving a status indicating a state of the printing; and
storing the status received in a storage module of a near field communication device.

12. The printing method according to claim 11, wherein
receiving comprises taking generation of a state in which the printing cannot be continued as a condition and storing a status from the printing received in the storage module of the near field communication device.

13. The printing method according to claim 11, wherein
storing comprises storing the status received in an auxiliary storage module, taking generation of a state in which the printing cannot be continued as a condition, and storing a status from the printing which relates to the generation of the state in which the printing cannot be continued from the auxiliary storage module to the storage module of the near field communication device.

14. The printing method according to claim 11, further comprising
storing information received from an external device via the near field communication device in the storage module of the near field communication device.

15. The printing method according to claim 11, wherein
if an amount of the statuses stored in the storage module of the near field communication device is greater than a threshold amount, overwriting a new status in a storage area in which an old status is stored.

16. The printing method according to claim 11, further comprising powering printing by battery power.

17. The printing method according to claim 11, wherein the printing is executed from a portable printer.

18. The printing method according to claim 11, wherein the status comprises error history information.

19. The printing method according to claim 11, wherein the near field communication device comprises an RFID tag.

20. The printing method according to claim 11, wherein the near field communication device comprises a non-contact type near field communication device.
